(19) United States
(12) Patent Application Publication
(10) Pub. No.: US 2010/0172729 A1
(43) Pub. Date: Jul. 8, 2010

(54) DEVICE FOR HANDLING A LOAD SUCH AS A SHEET IRON COIL

(75) Inventors: Pierre Marcelli, Laveze (FR); Julien Marcelli, Laveze (FR)

Correspondence Address: DAVIS & BUJOLD, P.L.L.C., 112 PLEASANT STREET, CONCORD, NH, 03301, US

(73) Assignee: ROTOBLOC-PSP SARL, Pirey (FR)

(21) Appl. No.: 12/602,027

(22) PCT Filed: May 28, 2008
(86) PCT No.: PCT/FR2008/000724

§ 371 Date: Nov. 25, 2009

(30) Foreign Application Priority Data
May 29, 2007 (FR) 0703779

(51) Int. Cl. B21C 47/24; B65H 19/00; B65G 7/08

(52) U.S. Cl. 414/684

(57) ABSTRACT

A device (30) for handling a load (C) such as a sheet iron coil comprises a holder (32) capable of carrying the load (C). The holder (32) is able to be rotated on a frame (31) between a first position, in which the axis of the load (C) is vertical, and a second position, in which the axis of the load (C) is horizontal. The frame (31) of the device (30) is coupled to a driving assembly (35) so as to be mobile in order to load and unload the load (C) on a reel (D). The holder (32) includes a mechanism for maintaining and positioning (36) the load (C), retaining the load (C) during a change of the position of the load, and depositing the load on and/or removing the load from the reel (D).

This application is a national stage completion of PCT/FR2008/000724 filed on May 28, 2008 which claims priority from French Application No. 07/03779 filed on May 29, 2007.

### TECHNICAL DOMAIN

The present invention concerns a device for handling a load such as a sheet iron coil comprising a holder capable of supporting the load, the holder moving rotationally on a frame between at least a first position in which the axis of the load is vertical, called the vertical axis position, and a second position in which the axis of the load is horizontal, called the horizontal axis position.

### PRIOR ART

In the field of metallurgy, strip steel, sheet iron and so forth packaged on reels called “coils” are used to feed production lines for metal pieces obtained by cutting, stamping, shaping, etc. These production lines are supplied by reels located at the head of the line to which the coils are transported by chucks with horizontal axes in most cases. Reels less than 500 mm wide are stacked, separated by support beams, and arranged in circles on pallets or the like for storage and transportation with the coil axes vertical. Consequently, it is necessary to lift each coil and tilt or pivot it a quarter turn before it can be loaded onto a reel so as to change the position of its axis from vertical to horizontal.

This is a relatively dangerous operation. At the present time it is accomplished in different ways:

By suspending each coil from a hook at the end of a sling supported by a moving crane;

By turning over each coil with the fork of a forklift (a very dangerous operation);

By tilting the unit consisting of the pallet and the stack of coils on a machine equipped with a ferrule or turning bracket called a “tilting device,” which is a very large and expensive machine. The major disadvantage to this solution is that it requires turning over the entire stack of coils, whereas only one coil or a portion of it may be required for production.

U.S. Pat. No. 4,322,198 proposes an automated solution which uses a bent rotating arm to change the position of the axis of the coil of metal supported by the arm. U.S. Pat. No. 3,395,813 proposes another automated solution using the weight of the coil to tilt a holder from a vertical axis position to a horizontal axis position, and maintaining it in that position controlled by an actuator.

Whatever the means used to turn the coil, the equipment or machines used are utilized uniquely for that operation. Once turning has taken place, it is necessary to load the reel. This complementary operation consists of taking up the coil so that its axis is horizontal, positioning it, and engaging it on the chuck of the reel at a point beyond the mid-point of the chuck jaws before depositing it.

Therefore, current solutions are incomplete and unsatisfactory, particularly from the point of view of operator safety. This problem exists in other technical domains such as the paper industry, plastics industry, etc., where materials are packed on coils or similar devices and the products to be handled are heavy.

### DESCRIPTION OF THE INVENTION

The present invention proposes a solution to the problem at hand with a handling device that is simple, economical, compact, reliable and secure, versatile, allows each coil to be turned individually, and combines the turning operation with the operations of loading and unloading any type of reel.

For this purpose, the invention concerns a handling device of the type indicated and characterized in that the frame is connected to a drive means allowing it to move so it is able to load and/or unload the load on another machine, such as a reel, and in that the support comprises a means of maintaining and positioning the load that grips the load while it changes position and deposits or takes up the load onto or from another machine.

According to variations of the invention, the rotational axis of the holder on the frame may be offset relative to the center of gravity of the holder including the load, the holder being designed to turn under the effects of gravity in a rotational direction that changes it from a vertical axis position to a horizontal axis position. In this case, turning the load in at least one direction of rotation is accomplished without using additional energy.

According to other variations of the invention, the axis of rotation of the holder on the frame may generally coincide with the holder's center of gravity inclusive of the load. In this case, the device advantageously comprises an additional driving means connected to the frame to turn it from its vertical axis position to its horizontal axis position and conversely.

In another variation, the frame may move translationally along guide rails and the drive means may comprise at least one actuator connected to the frame by a transmission.

The drive means is advantageously connected with the holder in order to turn it in the reverse direction of rotation so it passes from its horizontal axis position to its vertical axis position; this means may comprise a prop extending from a stop integral with the guide rails and an articulation integral with the holder opposite the axis of rotation.

In another embodiment, the actuation means may comprise a ramp with a fixed cam with a roller circulating on it that is integral with the holder opposite the rotational axis.

The guide rails are advantageously disposed in the extension of a reel and the actuation means, in this case, displaces the frame along a supplemental course for loading and unloading the reel when the holder is in horizontal axis position.

Preferably, the frame comprises a stop defining the holder's horizontal axis position.

The cam ramp may comprise a first inclined portion corresponding to the path of the frame while the holder rotates and a second horizontal portion corresponding to the supplemental loading and/or unloading path of the reel.

In another variation, the frame may be installed on a moving device that constitutes the drive means, and may comprise a lifting device for moving the frame upward.

The means of holding and positioning the load on the holder preferably moves in radial and/or axial translation and it may comprise a hook that contacts the interior bore in the load or a bed that contacts the exterior of the load.

The holder advantageously comprises a central opening to be traversed by the chuck of a reel during the operations of loading and unloading the load.

### SUMMARY DESCRIPTION OF THE DRAWINGS

The present invention and its advantages will be more readily apparent from the following description of several embodiments provided as non-limiting examples, with reference to the attached drawings, wherein:

FIG. 1 is a perspective view of a first embodiment of a handling device according to the invention;

FIGS. 2A through 2C are side views of the device of FIG. 1 respectively in the horizontal axis position, in the intermediate position, and in the vertical axis position;

FIGS. 3A-3D are detailed views of four variations of the positioning means provided on the device of FIG. 1;

FIGS. 4A through 4D are schemas of a variation of the device of FIG. 1 showing the four operational sequences involved in loading a coil onto the reel;

FIGS. 5A through 5D are schemas of another variation of the embodiment of FIG. 1 showing the same operational sequences as FIGS. 4A through 4D;

FIGS. 6A through 6D are schemas of a second form of embodiment of the device of FIG. 1 showing the same operational sequences; and

FIGS. 7A and 7B are perspectives of an indexing station for two coils respectively in the waiting position and during the loading process.

### ILLUSTRATIONS OF THE INVENTION AND VARIOUS EMBODIMENTS

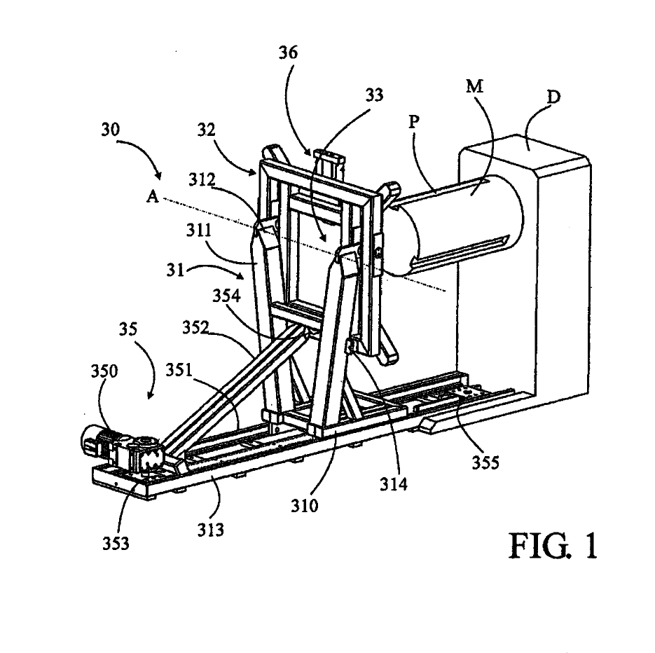

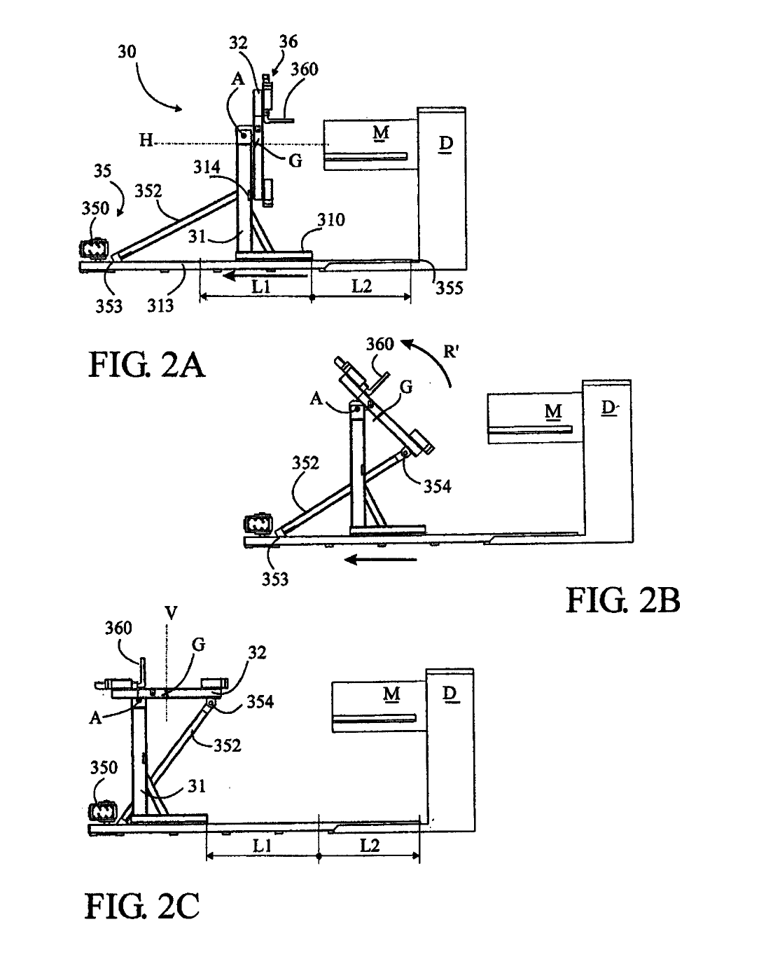

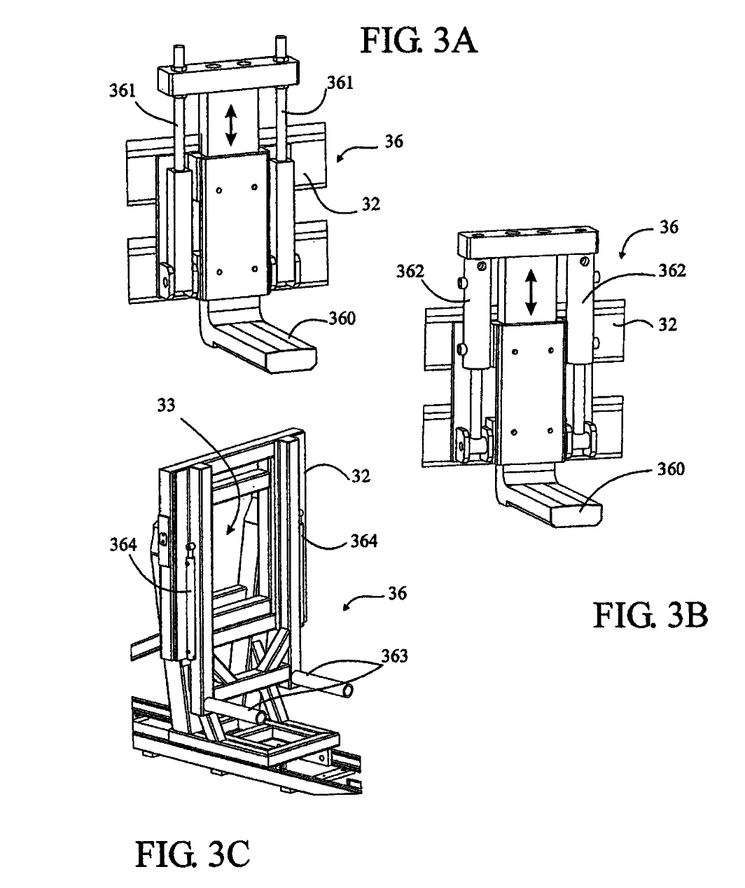

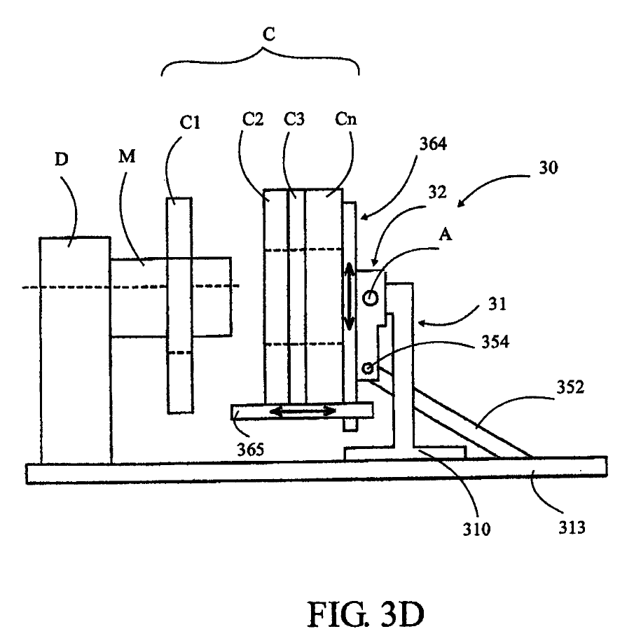

FIGS. 1 and 2 illustrate a first embodiment of a handling device 30 according to the invention designed to tilt a load C for a quarter turn and to also effect the loading and/or unloading of this load C onto another machine such as a reel D equipped with a chuck M for receiving load C. This load C may be a coil of sheet metal as shown in the drawings, deposited by a forklift or similar device, for the purpose of supplying a reel located at the head of a production line, or a partial coil of sheet metal to be removed from the reel. This load C may also consist of a stack of sheet iron coils as shown schematically in FIG. 3D for supplying a reel, the coils being deposited one after the other.

The handling device 30 comprises a frame 31 moving in translation along guide rails 313 attached to the floor in the axis of reel D, the frame being connected to a drive means 35. It comprises a pedestal 310 equipped with a roller device housed in guide rails 313, surmounted by a bracket 311 supporting at its free end a platform 312 defining rotational axis A. Frame 31 holds a holder 32 for receiving a load C such as a coil of sheet iron or the like. This holder 32 comprises a frame or similar piece rotationally movable about axis of rotation A between at least a vertical axis position V and a horizontal axis position H, and vice versa. Axis of rotation A in this example is offset from the center of gravity G of holder 32 such that turning holder 32 in clockwise direction R so it passes from its vertical axis position V to its horizontal axis position H is generated by the weight of load C on holder 32 by the pull of gravity G. This mechanism is not reversible, as turning in the opposite or counterclockwise direction R′ is generated by a driving means 35 detailed below.

Driving means 35 comprises an actuator 350 such as a reduction motor or similar means connected to frame 31 by a transmission such as a chain/pinion system 351 with the chain circulating in a closed loop within U-shaped guide rails 313, although any other known system may also be used. It also comprises a prop 352 extending between a fixed stop 353 integral with guide rails 313 and an articulation 354 integral with holder 32 opposite the axis of rotation A. This prop 352 ensures that holder 32 is locked in position and it also drives the holder 32 to rotate in a counterclockwise direction R′ causing it to pass from its horizontal axis position H to its vertical axis position V as shown in FIGS. 2A through 2C.

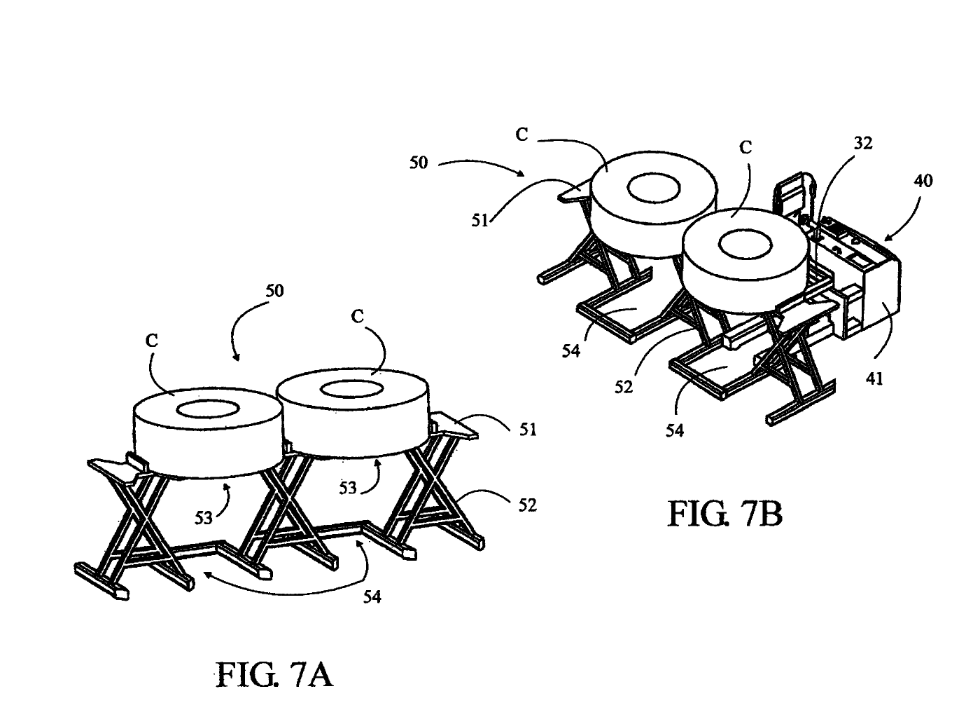

The operation of handling device 30 is explained with reference to FIGS. 2A through 2C in which the device is shown empty. In the position shown in FIG. 2C, handling device 30 is awaiting a load C; it is distanced from reel D and holder 32 is in the vertical axis position V. When a load C is deposited on holder 32, the holder remains blocked in its vertical axis position V by virtue of prop 352 contacting fixed stop 353. Engaging actuator 350 displaces frame 31 towards reel D and allows holder 32 to rotate due to the pull of gravity G. Articulation 354 on prop 352 describes an arc in counterclockwise direction R centered on fixed stop 353 until holder 32 attains the horizontal axis position H shown in FIG. 7A defined by a stop 314 located on frame 31 in which load C faces reel D. This first portion of the course taken by frame 31 is called the approach course L1. From this position, frame 31 continues its displacement toward reel D, driving with it prop 352, the base of which circulates in guide rails 313 as far as a block 355 at the end of the course that stops actuator 350 and defines the loading and/or unloading position of reel D. This second portion of the course taken by frame 31 is called the loading course L2. Load C can be transferred from holder 32 to chuck M as explained below.

Returning handling device 30 to its initial position illustrated in FIG. 2C is accomplished by reversing the rotational direction of actuator 350 to drive frame 31 in the opposite direction from reel D. Frame 31 retreats along course L2 driving prop 352 to its fixed stop 353 (cf. FIG. 2A). At this stage frame 31 pursues displacement opposite reel D and prop 352 causes holder 32 to rotate on its rotational axis A in counterclockwise direction R′ (cf. FIG. 2B) to pass from its horizontal axis position H to its vertical axis position V (cf. FIG. 2C).

Handling device 30 comprises a means 36 for maintaining and positioning load C on holder 32 to eliminate any risk of load C falling and to ensure its alignment with chuck M on reel D that will be loaded. For this purpose, holder 32 is preferably drilled to allow chuck M to pass through the holder 32. In the examples shown holder 32 consists of a frame defining a central opening 33 large enough to receive chuck M; in the example in FIG. 3A, the maintenance and positioning means 36 are shaped like a hook 360 that contacts the interior bore in load C. The hook 360 slides along holder 32 and its radial position can be adjusted using threaded rods 361 that allow the axis of load C to be aligned with the axis of chuck M on reel D. Consequently, this adjustment is performed at the time handling device 30 is put into service. In this case, reel D is equipped with an automatically expanding chuck M and the jaws of chuck M are disposed so as to form a passageway P (cf. FIG. 1) for hook 360 while reel D is being loaded and unloaded.

If reel D is equipped with a manual expansion chuck M, the hook 360 must move in radial translation on holder 32, for example, through the action of cylinders 362, as illustrated in FIG. 3B. This radial translation allows load C to be vertically deposited on the jaws of chuck M.

If chuck M on reel D does not permit hook 360 to pass through, then a positioning means 36 is designed to contact the exterior of load C, perhaps using a bed formed of contact rods 363, a V-shaped contact, or similar device. In this case the positioning means 36 also moves in radial translation on holder 32, for example, through the action of cylinders 364 in order to adapt to the exterior diameter of load C.

Handling device 30, according to the invention, can also be designed to turn a load C consisting of a stack of several coils of sheet iron C1, C2, C3, Cn, however they are packaged, as shown in FIG. 3D. In this example, the positioning means 36 move radially on holder 32 through the action of cylinders 364 and support the exterior diameter of load C using axially movable contact arms 365. Contact arms 365 move axially so as to permit one single coil C1 at a time to be deposited on chuck M of reel D. In a variation, the positioning means 36 may also support load C through its interior bore as in the examples of FIGS. 3A and 3B, and in this case, hook 360 also moves axially.

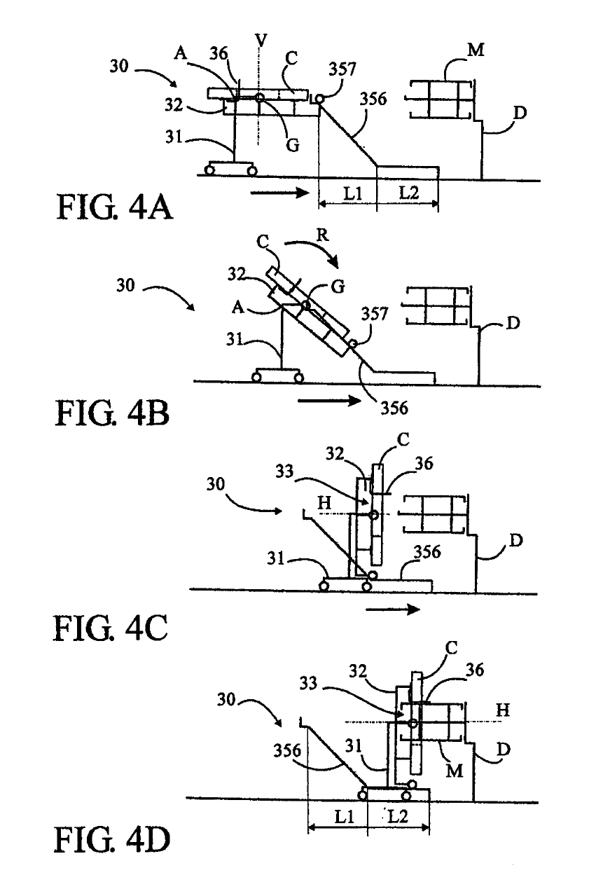

Other mechanisms may also be used associated with the drive means 35 to ensure displacement of frame 31 in two steps L1 and L2, the first step L1 corresponding to the approach course in which holder 32 is turned for a quarter turn to place the axis of load C in horizontal position aligned with the axis of chuck M of reel D, and the second step L2 corresponding to the loading course loading load C on reel D. An example is shown schematically in FIGS. 4A through 4D, using a fixed cam ramp 356 along which a roller 357 or similar element circulates integral with holder 32 opposite rotational axis A. Cam ramp 356 comprises a first inclined portion corresponding to course L1 during which frame 31 is displaced translationally toward reel D and holder 32 moves from its vertical axis position V to its horizontal axis position H (cf. FIGS. 4A and 4B), followed by second horizontal portion corresponding to course L2 during which frame 32 pursues translational displacement to place load C at a right angle to chuck M. of reel D (cf. FIGS. 4C and 4D). FIG. 4D illustrates how handling device 30 of the invention allows reel D to be loaded without resorting to other handling equipment, thanks to holder 32 which allows chuck M to pass through its central opening 33 in order to deposit load C therein when chuck M is extended.

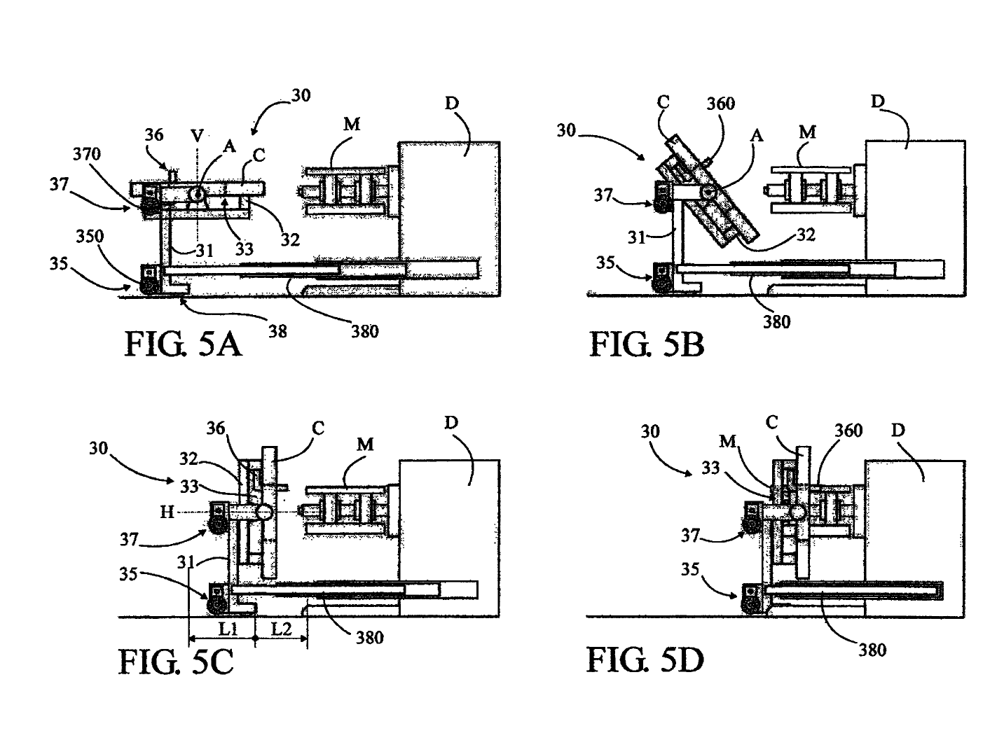

FIGS. 5A through 5D illustrate another variation of the handling device 30 of the invention in which rotational axis A of holder 32 generally coincides with the center of gravity G of the supplemental holder 32 for load C, and in which tipping the holder 32 between its vertical axis position V and its horizontal axis position H and vice versa is accomplished using an additional drive means 37. This means comprises an actuator 370 such as a motor, a reduction motor, a cylinder connected either directly or through a rack and pinion or similar mechanical transmission to a drive shaft that coincides with rotational axis A. The vertical axis position V and horizontal axis position H are defined either by programming actuator 370 or by the course limits located on frame 31 and not shown. In this variation, frame 31 is attached to a moving device 38 and connected to reel D by rails or telescoping guides 380 which define the courses L1 and L2 followed by handling device 30 that are necessary for loading and unloading reel D. Naturally the displacement of frame 31 is controlled by actuator 350 and any type of mechanical transmission connected to the rails or telescoping guides 380. Just as in the preceding embodiments, holder 32 comprises a central opening 33 for the passage of chuck M while reel D is being loaded, as well as a maintenance and positioning means 36 for load C, for example, in the shape of a radially adjustable hook 360.

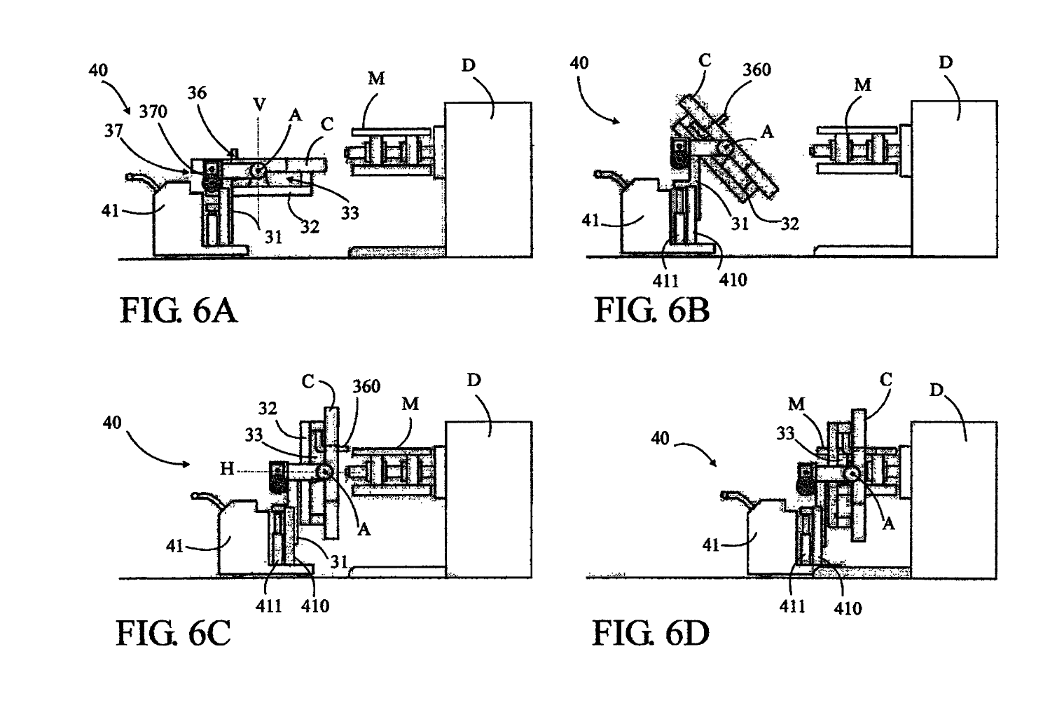

FIGS. 6A and 6D illustrate a second embodiment of a handling device 40 according to the invention in which frame 31 is on a mobile device 41 maneuvered by an operator, the mobile device 41 constituting the drive means for the frame 31 and offering the advantage of not being dedicated to one particular reel D, but capable of supplying different reels D with the same device. Frame 31 is similar to the preceding example and it also comprises a supplemental drive means 37 to turn holder 32 from a vertical axis position V to a horizontal axis position H and vice versa. Holder 32 is also like the preceding examples in that it comprises a central opening 33 for the passage of chuck M and a means 36 for maintaining and positioning load C. Mobile device 41 comprises vertical guide columns 410 or similar elements inside or upon which frame 31 and lifting means 411 slide, for example, in the form of cylinders, to displace frame 31 vertically and be able to position holder 32 relative to the axis of chuck M of a given reel D. This design allows handling device 40 to be versatile and adaptable to various types of reels D.

In this second embodiment it is possible to have indexing stations 50 near reels D (cf. FIGS. 7A and 7B) to collect at least two coils C waiting alongside each other in vertical axis position to be lifted by handling device 40: for example, one full coil waiting to be loaded onto reel D and one partial coil coming off reel D. This indexing station 50 comprises a receiving platform 51 supported by feet 52. In the example shown receiving platform 51 comprises at right angles to each coil C a central opening 53 to allow holder 32 on handling device 40 to pass below coil C. Similarly, feet 52 define at right angles to each coil C an index housing 54 for receiving the feet of mobile device 41 in order to load a waiting coil. In this case, lifting means 411 of holding device 40 allows holder 32 to be lowered below the coil C that will be taken up.

Obviously, the exemplary embodiments in FIGS. 5 and 6 may comprise a holder 32 similar to the embodiments in FIGS. 1 through 4 with its center of gravity offset relative to rotational axis A in order to eliminate any additional drive means 37.

It is clear from this description that the invention attains its stated objectives, that is, simple, economical, secure, and versatile handling devices that perform both the operations of loading and unloading one or more reels, as well as turning load C.

The present invention is not limited to the exemplary embodiments described, but extends to any modification and variation evident to a person skilled in the art while remaining within the scope of protection defined in the attached claims.

1-16. (canceled)

17. A device (30, 40) for holding a load (C) such as a sheet iron coil comprising:
a holder (32) for supporting the load, the holder moving rotationally on a frame (31) between at least a first position in which an axis of the load is in a vertical axis position (V), and a second position in which another axis of the load is in a horizontal axis position (H), and the frame (31) being connected to a drive means (35, 41) to be mobile and at least one of load and discharge the load (C) onto another machine such as a reel (D), and the holder (32) comprising a means (36) for maintaining and positioning the load (C) for at least one of holding the load (C) while its position is being changed and taking the load (C) on or from the machine,
the holder (32) comprises a central opening (33) that is traversable by a chuck (M) on the reel (D), during the loading and the unloading the load (C), and the means (36) for maintaining and positioning the load moving in at least one of a radial and an axial translation along the holder (32) to align the axis of the load (C) with an axis of the chuck (M) of the reel (D) during the loading and the unloading the load.

18. The handling device according to claim 17, wherein a rotational axis (A) of the holder (32) on the frame (31) is offset relative to a center of gravity (G) of the holder (32) carrying the load (C), the holder is designed to turn by a gravitational force in a direction of rotation (R) to pass from the vertical axis position (V) to the horizontal axis position (H).

19. The handling device according to claim 17, wherein a rotational axis (A) of the holder (32) on the frame (31) coincides with a center of gravity (G) of the holder (32) carrying the load (32) and an additional drive means (37) is connected to the holder (32) to turn the holder (32) from the vertical axis position (V) to the horizontal axis position (H), and vice versa.

20. The device according to claim 17, wherein the frame (31) moves translationally within guide rails (313, 380) and the drive means (35) comprises at least one actuator (350) connected to the frame (31) by a transmission (351).

21. The device according to claim 18, wherein the drive means (35) is connected to the holder (32) to turn the holder (32) in a reverse direction of rotation (R′) to pass from the horizontal axis position (H) to the vertical axis position (V).

22. The device according to claim 20, wherein the drive means (35) comprises a prop (352) extending between a fixed stop (353) integral with the guide rails (313) and an articulation (354) integral with the holder (32) opposite a rotational axis (A), the prop (352) being designed to block the holder (32) in the vertical axis position (V).

23. The device according to claim 21, wherein the drive means (35) comprises a fixed cam ramp (356) along which there circulates a guide roller (357) that is integral with the holder (32) opposite the rotational axis (A).

24. The device according to claim 22, wherein the guide rails (313) are located in an extension of the reel (D) and the drive means (35) is designed to displace the frame (31) along a supplemental course (L2) to at least one of load and unload the reel (D) when the holder (32) is in the horizontal axis position (H).

25. The device according to claim 24, wherein the frame (31) comprises at least one stop (314) defining at least the horizontal axis position (H) of the holder (32).

26. The device according to claim 24, wherein the cam ramp (356) comprises a first portion corresponding to a path (L1) of the frame (31) while the holder (32) is rotating and a second portion corresponding to at least one of the supplemental loading and unloading course (L2) of the reel (D).

27. The device according to claim 17, wherein the frame (31) is associated with a moving device (41) that constitutes the drive means.

28. The device according to claim 27, wherein the moving device (41) comprises a lifting means (411) for positioning the frame (31) at a top location.

29. The device according to claim 17, wherein the maintenance and positioning means (36) for the load (C) comprises a hook (360) for contacting an interior bore in the load (C).

30. The device according to claim 17, wherein the maintenance and positioning means (36) for the load (C) comprises a bed (363) that contacts the exterior of the load (C).
